(19) United States
(12) Patent Application Publication
(10) Pub. No.: US 2025/0265244 A1
(43) Pub. Date: Aug. 21, 2025

(54) SYSTEM FOR SEARCHING SURVEILLANCE RECORDS USING NATURAL LANGUAGE QUERIES

(71) Applicant: GENETEC INC., St-Laurent (CA)

(72) Inventors: Florian Matusek, Vienna (AT); Georg Agustin Zankl, Vienna (AT)

(21) Appl. No.: 19/060,550

(22) Filed: Feb. 21, 2025

Related U.S. Application Data
(60) Provisional application No. 63/714,295, filed on Oct. 31, 2024.
(60) Provisional application No. 63/670,433, filed on Jul. 12, 2024.
(60) Provisional application No. 63/556,196, filed on Feb. 21, 2024.

(51) Int. Cl. G06F 16/2452; G06F 16/248

(52) U.S. Cl. CPC G06F 16/24522; G06F 16/248

(57) ABSTRACT

A system for causing a searching of a data source of surveillance records; it has a processor; and memory comprising program code that, when executed by the processor, cause the processor to obtain an input query, the input query comprising natural language; provide the input query to a large language model (LLM), for translating the natural language into a structured data source query based on searchable categories associated with the surveillance records stored in the data source; obtain, from the LLM, a structured data source query based on the input query; transmit the structured data source query to the data source to perform a search of the data source in accordance with the structured data source query to identify at least one query result; and receive the at least one query results; a method of use thereof.

The present disclosure claims priority from U.S. provisional patent application No. 63/714,295, filed on Oct. 31, 2024, incorporated herein by reference, claims priority from U.S. provisional patent application No. 63/670,433 filed on Jul. 12, 2024, incorporated herein by reference, and claims priority from U.S. provisional patent application No. 63/556,196 filed on Feb. 21, 2024, incorporated herein by reference.

### TECHNICAL FIELD

The present disclosure relates generally to physical security and surveillance, and more specifically to querying repositories of surveillance data.

### BACKGROUND

A surveillance system is a network of various devices employed to monitor activities and behaviours of persons, vehicles, or the like in a particular area being surveilled. A surveillance system may collect information from a variety of sources, centralize that information, and make the information available to surveillance personnel to aid them in making decisions relating to the safety of persons or other objects within the area being surveilled. A surveillance network may include any suitable number of devices for collecting information, including cameras, microphones, access card readers, and the like, as well as any number of monitors or other interfaces for presenting information to operators of the surveillance system. In the case of a video surveillance system, information (e.g., video streams) acquired by cameras or similar devices may be centralized in a video management system (VMS). Other types of surveillance data, such as access control records, intrusion detection records, event records, records relating to intercom calls or other voice communications, and the like, may also be stored in suitable systems: in some cases, a unified security platform may serve as a VMS and to store other types of surveillance records.

The overwhelming majority of surveillance records are never accessed after initial recording and/or viewing. This is because most surveillance records contain no evidence of situations requiring investigation, and thus are of limited interest. However, for a variety of reasons, it is very uncommon for operators of the surveillance system to delete surveillance records before a predetermined retention period has elapsed. This means that operators searching the surveillance records for events where persons or vehicles of interest are present must comb through all the records produced by the surveillance system, which is an arduous and time-consuming task.

Thus, improved approaches for searching through surveillance records are desirable.

### SUMMARY

The following presents a simplified summary of one or more implementations in accordance with aspects of the present disclosure in order to provide a basic understanding of such implementations, without limiting the embodiments presented within the present disclosure.

A surveillance repository may contain any suitable number of surveillance records, including video records, audio records, image records, text records, event records, and the like. In order to facilitate searching through the repository, an operator may provide a search query via a user interface of a computer. The search query make take any suitable form, including natural language: that is to say, in the form of everyday parlance, as spoken or written by people.

Prior art systems suffer from the disadvantage that they tend to be fixed. In the past, systems relied on deterministic algorithmic conversion of text to database system queries, which would involve parsing the text to extract label and using a thesaurus to identify searchable terms in the labels. With the advent of AI, more complex systems could be made by training AI models using sets of user input queries and corresponding valid search queries. Both of these may be suitable if the searchable things do not change. However, recent and complex surveillance systems include ever increasing capabilities and searchable things. For example, new hardware may be supported to detect and record new things, or cameras may support new analytics to identify new metadata (e.g. detect different types of objects (e.g. luggage), new characteristics to objects that have previously detected (e.g. level of damage on a car), or existing types of objects may be expanded (e.g. new vehicle makes and models)). The present disclosure provides a system that can be easily updated to reflect new searchable parameters without requiring a reprograming, a complex AI re-training and without necessarily requiring a software update. To this end, a general-purpose or non-dedicated-purpose AI model (in the primary example, a Large Language Model (LLM)) may be used and be adapted on-the-fly. This has the further advantage of allowing the present subject matter to benefit from improvements in AI models provided by external providers and to avoid a need to train an AI model or program a deterministic algorithm. The LLM produces a structured data source query based on the input query, and the repository is searched using the structured data source query to identify one or more query results. The query results may then be displayed via the user interface, for instance for review by the operator.

In accordance with a broad aspect, there is provided a method for searching a repository of surveillance records. An input query comprising natural language is obtained via a user interface. The input query is provided to a large language model (LLM), the LLM having been trained to translate natural language into data source queries structured based on metadata categories associated with the surveillance records stored in the repository. A structured data source query, based on the input query, is obtained from the LLM. The repository is searched using the structured data source query to identify at least one query result. The at least one query result is displayed via the user interface.

In at least some embodiments according to any one or more of the previous embodiments, the LLM may have been trained to translate natural language into data source queries comprising of one or more query couplets composed of a metadata category and a metadata characteristic.

In at least some embodiments according to any one or more of the previous embodiments, the LLM may have been trained to translate natural language into data source queries without producing any intermediary elements.

In at least some embodiments according to any one or more of the previous embodiments, providing the input query to the LLM may include providing the input query to the LLM without prior parsing of the input query.

In at least some embodiments according to any one or more of the previous embodiments, the LLM may have been trained to translate natural language into data source queries by predicting terms for the structured data source query as future tokens for the input query.

In at least some embodiments according to any one or more of the previous embodiments, the LLM predicting terms for the structured data source query may be performed without parsing the input query.

A broad aspect is a method for causing a searching of a data source of surveillance records. The method includes obtaining an input query, the input query comprising natural language; providing the input query to a large language model (LLM), for translating the natural language into a structured data source query based on searchable categories associated with the surveillance records stored in the data source; obtaining, from the LLM, a structured data source query based on the input query; transmitting the structured data source query to the data source to perform a search of the data source in accordance with the structured data source query to identify at least one query result; and receiving the at least one query results.

In some embodiments, the method may include causing a display, via the user interface, of the at least one query result.

In some embodiments, the searchable categories may be metadata categories.

In some embodiments, the searchable categories may form with corresponding metadata characteristics query couplets.

In some embodiments, providing the input query to the LLM may include providing the input query to the LLM without prior parsing of the input query.

In some embodiments, the method may include generating and transmitting instructions to the LLM for generating an application programming interface (API) call for an API related to a data source to be queried with the structured data source query.

In some embodiments, the method may include transmitting the at least one query results to the LLM; and generating and transmitting instructions to the LLM to generate a summary of the at least one query result.

In some embodiments, the method may include providing a permission level to the LLM, wherein the obtained structured data source query may include information related to the permission level.

In some embodiments, the method may include transmitting the at least one query result to the LLM; generating and transmitting instructions to the LLM for causing the LLM to analyse the at least one query result; receiving the output of the analysis from the LLM; and providing a response to a user computing device having generated the input query, the response corresponding to the received output.

In some embodiments, the instructions for causing the LLM to analyse the at least one query results may further cause the LLM to compare the at least one query result to the input query or the structured data source query to verify if the at least one query result satisfies the input query or the structured data source query.

In some embodiments, the instructions may further cause the LLM to interpret the at least one query results to determine if additional search of the data source, or of one or more additional data sources is required.

In some embodiments, the instructions may further cause the LLM to interpret the at least one query results to determine if a category of information identified in the input query is not searchable.

In some embodiments, the instructions may further cause the LLM to generate as an output a suggestion of an alternative category of information instead of the category of information identified in the input query that is not searchable.

In some embodiments, the method may include generating and transmitting instructions to the LLM for causing the LLM to analyze the input query to determine if one or more categories of information related to the input query is not searchable; and receiving an output from the LLM regarding if one or categories of information related to the input query is not searchable.

In some embodiments, the instructions to the LLM for causing the LLM to analyze the input query to determine if one or more categories of information related to the input query is not searchable, may be to further cause the LLM to generate one or more alternative data categories to be searched related to one or more not searchable categories of information of the one or more categories of information; and wherein the received output may include the one or more alternative data categories to be searched related to one or more not searchable categories of information of the one or more categories of information.

In some embodiments, the obtained input query may be accompanied by metadata providing context information surrounding the obtained input query.

In some embodiments, the input query may be provided to the LLM along with the metadata providing context information or information derived from the metadata providing context information.

In some embodiments, the method may include generating a system prompt defining instructions on a manner of structuring the structured data prompt for the data source, and providing the system prompt along with the input query to the LLM.

Another broad aspect is a system for causing a searching of a data source of surveillance records. The system includes a processor; and memory comprising program code that, when executed by the processor, cause the processor to: obtain an input query, the input query comprising natural language; provide the input query to a large language model (LLM), for translating the natural language into a structured data source query based on searchable categories associated with the surveillance records stored in the data source; obtain, from the LLM, a structured data source query based on the input query; transmit the structured data source query to the data source to perform a search of the data source in accordance with the structured data source query to identify at least one query result; and receive the at least one query results.

In some embodiments, the program code may further cause the processor to cause a display, via the user interface, of the at least one query result.

In some embodiments, the data categories may be metadata categories.

In some embodiments, the metadata categories may form with corresponding metadata characteristics query couplets.

In some embodiments, providing the input query to the LLM may include providing the input query to the LLM without prior parsing of the input query.

In some embodiments, the program code may further cause the processor to generate and transmit instructions to the LLM for generating an application programming interface (API) call for an API related to a data source to be queried with the structured data source query.

In some embodiments, the program code may further cause the processor to: transmit the at least one query results to the LLM; and generate and transmitting instructions to the LLM to generate a summary of the at least one query result.

In some embodiments, the program code may further cause the processor to provide a permission level to the LLM, wherein the obtained structured data source query may include information related to the permission level.

In some embodiments, the program code may further cause the processor to: transmit the at least one query result to the LLM; generate and transmitting instructions to the LLM for causing the LLM to analyse the at least one query result; receive the output of the analysis from the LLM; and provide a response to a user computing device having generated the input query, the response corresponding to the received output.

In some embodiments, the instructions for causing the LLM to analyse the at least one query results may further cause the LLM to compare the at least one query result to the input query or the structured data source query to verify if the at least one query result satisfies the input query or the structured data source query.

In some embodiments, the instructions may further cause the LLM to interpret the at least one query results to determine if additional search of the data source, or of one or more additional data sources is required.

In some embodiments, the instructions may further cause the LLM to interpret the at least one query results to determine if a category of information identified in the input query is not searchable.

In some embodiments, the instructions may further cause the LLM to generate as an output a suggestion of an alternative category of information instead of the category of information identified in the input query that is not searchable.

In some embodiments, the program code may further cause the processor to: generate and transmitting instructions to the LLM for causing the LLM to analyze the input query to determine if one or more categories of information related to the input query is not searchable; and receive an output from the LLM regarding if one or categories of information related to the input query is not searchable.

In some embodiments, the instructions to the LLM for causing the LLM to analyze the input query to determine if one or more categories of information related to the input query is not searchable, may be to further cause the LLM to generate one or more alternative data categories to be searched related to one or more not searchable categories of information of the one or more categories of information; and wherein the received output may include the one or more alternative data categories to be searched related to one or more not searchable categories of information of the one or more categories of information.

In some embodiments, the obtained input query may be accompanied by metadata providing context information surrounding the obtained input query.

In some embodiments, the input query may be provided to the LLM along with the metadata providing context information or information derived from the metadata providing context information.

In some embodiments, the program code may further cause the processor to generate a system prompt defining instructions on a manner of structuring the structured data prompt for the data source, and providing the system prompt along with the input query to the LLM.

Another broad aspect is non-transitory computer-readable medium having stored thereon program instructions for causing a searching of a data source of surveillance records, the program instructions executable by a processing unit for: obtaining an input query, the input query comprising natural language; providing the input query to a large language model (LLM), for translating the natural language into a structured data source query based on searchable categories associated with the surveillance records stored in the data source; obtaining, from the LLM, a structured data source query based on the input query; transmitting the structured data source query to the data source to perform a search of the data source in accordance with the structured data source query to identify at least one query result; and receiving the at least one query results.

In some embodiments, the program instructions may be further executable by the processing unit for causing a display, via the user interface, of the at least one query result.

In some embodiments, the data categories may be metadata categories.

In some embodiments, the metadata categories may form with corresponding metadata characteristics query couplets.

In some embodiments, providing the input query to the LLM may include providing the input query to the LLM without prior parsing of the input query.

In some embodiments, the program instructions may be further executable by the processing unit for generating and transmitting instructions to the LLM for generating an application programming interface (API) call for an API related to a data source to be queried with the structured data source query.

In some embodiments, the program instructions may be further executable by the processing unit for transmitting the at least one query results to the LLM; and generating and transmitting instructions to the LLM to generate a summary of the at least one query result.

In some embodiments, the program instructions may be further executable by the processing unit for providing a permission level to the LLM, wherein the obtained structured data source query may include information related to the permission level.

In some embodiments, the program instructions may be further executable by the processing unit for: transmitting the at least one query result to the LLM; generating and transmitting instructions to the LLM for causing the LLM to analyse the at least one query result; receiving the output of the analysis from the LLM; and providing a response to a user computing device having generated the input query, the response corresponding to the received output.

In some embodiments, the instructions for causing the LLM to analyse the at least one query results may further cause the LLM to compare the at least one query result to the input query or the structured data source query to verify if the at least one query result satisfies the input query or the structured data source query.

In some embodiments, the instructions may further cause the LLM to interpret the at least one query results to determine if additional search of the data source, or of one or more additional data sources is required.

In some embodiments, the instructions may further cause the LLM to interpret the at least one query results to determine if a category of information identified in the input query is not searchable.

In some embodiments, the instructions may further cause the LLM to generate as an output a suggestion of an alternative category of information instead of the category of information identified in the input query that is not searchable.

In some embodiments, the program instructions may be further executable by the processing unit for: generating and transmitting instructions to the LLM for causing the LLM to analyze the input query to determine if one or more categories of information related to the input query is not searchable; and receiving an output from the LLM regarding if one or categories of information related to the input query is not searchable. In some embodiments, the instructions to the LLM for causing the LLM to analyze the input query to determine if one or more categories of information related to the input query is not searchable, may be to further cause the LLM to generate one or more alternative data categories to be searched related to one or more not searchable categories of information of the one or more categories of information; and wherein the received output includes the one or more alternative data categories to be searched related to one or more not searchable categories of information of the one or more categories of information.

In some embodiments, the obtained input query may be accompanied by metadata providing context information surrounding the obtained input query.

In some embodiments, the input query may be provided to the LLM along with the metadata providing context information or information derived from the metadata providing context information.

In some embodiments, the program instructions may be further executable by the processing unit for generating a system prompt defining instructions on a manner of structuring the structured data prompt for the data source, and providing the system prompt along with the input query to the LLM.

Another broad aspect is a method for updating a surveillance records search tool for searching data source of surveillance records, the data source having searchable parameters. The method includes providing a data representation of a system prompt to be transmitted along with user query to an AI model, the system prompt defining instructions on a manner of structuring a structured data prompt for the data source in accordance with the searchable parameters of the data source; modifying, replacing or supplementing the data representation of the system prompt to define instructions on a manner of structuring a structured data prompt for the data source in accordance with different searchable parameters of the data source; obtaining an input query, the input query comprising natural language; accessing the data representation of the system prompt; and generating an LLM query for a large language model (LLM) comprising a portion made with the input query and a portion made with the data representation of the system prompt.

In some embodiments, the data representation of the system prompt may be a text containing the system prompt.

In some embodiments, the LLM query may include the input query and the system prompt.

In some embodiments, the data representation of the system prompt may contain template elements each comprising portions of a potential system prompt, and wherein to generate an LLM query may include building a system prompt with a subset of the template elements.

In some embodiments, building the subset of template elements may be selected on the basis of the user query.

Another broad aspect is a non-transitory computer-readable medium having stored thereon program instructions for updating a surveillance records search tool for searching data source of surveillance records, the data source having searchable parameters, the non-transitory computer-readable medium having stored thereon a data representation of a system prompt to be transmitted along with user query to an AI model, the system prompt defining instructions on a manner of structuring a structured data prompt for the data source in accordance with the searchable parameters of the data source the program instructions executable by a processing unit for: providing a data representation of a system prompt to be transmitted along with user query to an AI model, the system prompt defining instructions on a manner of structuring a structured data prompt for the data source in accordance with the searchable parameters of the data source; modifying, replacing or supplementing the data representation of the system prompt to define instructions on a manner of structuring a structured data prompt for the data source in accordance with different searchable parameters of the data source; obtaining an input query, the input query comprising natural language; accessing the data representation of the system prompt; and generating an LLM query for a large language model (LLM) comprising a portion made with the input query and a portion made with the data representation of the system prompt.

In some embodiments, the data representation of the system prompt may be a text containing the system prompt.

In some embodiments, the LLM query may include the input query and the system prompt.

In some embodiments, the data representation of the system prompt may contain template elements each comprising portions of a potential system prompt, and wherein to generate an LLM query may include building a system prompt with a subset of the template elements.

In some embodiments, building the subset of template elements may be selected on the basis of the user query.

Another broad aspect is a system for updating a surveillance records search tool for searching data source of surveillance records, the data source having searchable parameters comprising: a processor; and memory comprising a data representation of a system prompt to be transmitted along with user query to an AI model, the system prompt defining instructions on a manner of structuring a structured data prompt for the data source in accordance with the searchable parameters of the data source; program code that, when executed by the processor, cause the processor to modify, replace or supplement the data representation of the system prompt to define instructions on a manner of structuring a structured data prompt for the data source in accordance with different searchable parameters of the data source; program code that, when executed by the processor, cause the processor to: obtain an input query, the input query comprising natural language; access the data representation of the system prompt; and generate an LLM query for a large language model (LLM) comprising a portion made with the input query and a portion made with the data representation of the system prompt.

In some embodiments, the data representation of the system prompt may be a text containing the system prompt.

In some embodiments, the LLM query may include the input query and the system prompt.

In some embodiments, the data representation of the system prompt may contain template elements each comprising portions of a potential system prompt, and wherein to generate an LLM query may include building a system prompt with a subset of the template elements.

In some embodiments, building the subset of template elements may be selected on the basis of the user query.

### BRIEF DESCRIPTION OF THE DRAWINGS

The invention will be better understood by way of the following detailed description of embodiments of the invention with reference to the appended drawings, in which:

FIGS. 1A-1B are exemplary graphical user interfaces for a search application.

FIGS. 2, 3, and 4 are exemplary graphical user interfaces for a search application;

FIG. 5 is a block diagram of an example computing system.

FIG. 6 is a block diagram of an exemplary surveillance software platform;

FIG. 7 is a flowchart illustrating an exemplary method for searching a repository of surveillance records;

FIG. 8 is a block diagram of an exemplary system for querying one or more data sources using an LLM, in communication with one or more client computing devices, one or more data sources and one or more server;

FIG. 9 is a block diagram of exemplary software architecture for querying one or more data sources using a structured data source query generated an LLM; and

FIG. 10 is a flowchart diagram of an exemplary method for querying one or more data sources using a structured data source query generated by an LLM.

### DETAILED DESCRIPTION

The present disclosure relates to, inter alia, methods, systems, devices, and computer-readable media for searching a repository of surveillance records, which may include video records, audio records, image records, text records, event records, and the like. The repository may be structured in any suitable fashion, including as a relational data source or other type of data source, and may associated various metadata with each entry. In addition, although reference will be made herein to searching of the repository, it should be understood that searching of real-time or near-real-time events and entities is also considered.

### Exemplary System for Generating a Structured Data Source Query Using an LLM:

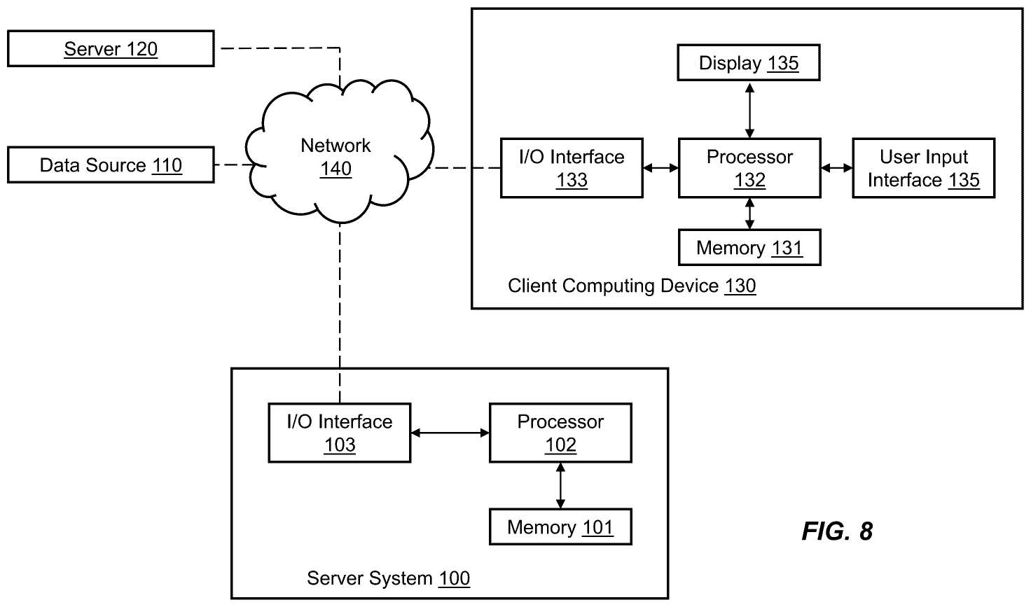

Reference is made to FIG. 8, illustrating an exemplary server system 100 for generating a structured data source query using a Large Language Model (LLM), for querying a data source. The system 100 is in communication with one or more external servers 120 and one or more client computing devices 130 for a user, and one or more data sources 110.

The system 100 includes a processor 102, memory 101 and an I/O interface 103.

The processor 102 may be a general-purpose programmable processor. In the example of FIG. 8, the processor 102 is shown as being unitary, but the processor 102 may also be multicore, or distributed (e.g. a multi-processor).

The computer readable memory 101 stores program instructions and data used by the processor 102. The memory 101 stores, for instances, user input queries, structured data source queries, query results, etc. The computer readable memory 101, though shown as unitary for simplicity in the example of FIG. 8, may comprise multiple memory modules and/or caching. In particular, the memory 101 may comprise several layers of memory such as a hard drive, external drive (e.g. SD card storage) or the like and a faster and smaller Random Access Memory (RAM) module. The RAM module may store data and/or program code currently being, recently being or soon to be processed by the processor 102 as well as cache data and/or program code from a hard drive. A hard drive may store program code and be accessed to retrieve such code for execution by the processor 102 and may be accessed by the processor 102 to store and access data. The memory 101 may have a recycling architecture for storing, for instance, structured search queries, search history, input queries, etc., where older data files are deleted when the memory 101 is full or near being full, or after the older data files have been stored in memory 101 for a certain time.

The I/O interface(s) 103 is in communication with the processor 102. The I/O interface(s) 103 may include a network interface and may be a wired or wireless interface for establishing a remote connection with, for example, one or more data sources 110 (e.g. through application program interface(s)-API(s)) via a network 140 (e.g. the Internet), and/or one or more servers 120 and/or one or more client computing devices 130. For instance, the I/O interface(s) 103 may be an Ethernet port, a WAN port, a TCP port, etc.

The processor 102, the memory 101 and the I/O interface(s) 103 may be linked via bus connections.

The client computing device 130 may be a remote computing device (i.e. client). One or more client computing devices 130 may be provided.

The client computing device 130 is in communication with the I/O interface(s) 103 of the server system 100. The computing device 130 has a processor 132, a memory 131, I/O interface(s) 133 that may be linked via bus connections. The computing device 130 may have (or be connected to) any user input interface 135, for example, such as a keyboard, a mouse, a touchscreen, etc. The computing device 130 may be a desktop computer, a laptop, a smartphone, a tablet, etc. The computing device 130 has (or is adapted to connect to) a display 135 (e.g. a screen, a tactile display, etc.). The processor 132, the memory 131 and the I/O interface(s) 133 may be similar to the processor 102, the memory 101 and the I/O interface(s) 103, respectively.

A client application program may be stored in memory of the computing device 130 that is associated with the server system 100, the client application program providing the user with an interface to interact with the server system 100. The client application program may be for interacting with the application program that is associated with the LLM tool (e.g. for inputting the input query as a string of characters, a selection of one or more options for different fields of information to be queried, etc.)

The client computing device 130 may be operated by user(s) to access a webpage or graphical user interface (GUI) for interacting with the application program associated with the LLM tool, the application program managed by the system 100.

The system 100 may be in communication with one or more data sources 110 via the network 140. The system 100 may be in communication with one or more client computing device 130 via the network 140. The system 100 may be in communication with one or more external servers 120 via the network 140.

Similarly, the/a retrieval of one or more surveillance records corresponding to the structured database query.

In some instances, the functionality of the one or more servers 120 may be integrated into the system 100, where the system 100 is configured to run the LLM tool and the application program that is associated with the LLM tool. More specifically, it is possible to run locally hosted AI models, including LLMs. In alternate embodiments, the function of the LLM described herein is implemented by a local LLM.

In some instances, the system 100 may be the same device as the client computing device 130, where the program code for improving the output of the LLM is stored in memory of the client computing device 130. For example, in the instant example, a cloud-based system physical security system may be provided, including for example a video management system (VMS), access control system (ACS) or the like, whereby the system is implemented principally on server system 100 which may be a cloud-bases system. In this example, the client computing device 130 may be running locally to the user on a computer or like device where a client application runs that allows access to the cloud-based system 100. Data sources 110 may be implemented in Cloud storage. Server 120 may host an external service, typically also Cloud-based. For example, GPT services from Azure Open AI services may be used. These are typically accessed via API calls to the service which the system 100 creates and transmits.

Other architectures are possible. In other examples, for example, a local “on premises” system may be provided. In such systems, you a server-client architecture may be present where the functionality of server system 100 is provided on a server and the client computing device 130 is another local computing device communicating with the server system over a network. In such an example, the data source 110 tends to be server storage. It is possible that in simpler systems, the server system 100 and client computing device 130 are implemented by the same physical device, however this is not common in complex deployments or ones requiring complex searching systems.

The data source(s) 110 includes or stores surveillance records to be queried following receipt of the structured data source query generated by the LLM. The data source(s) 110 may be repositories of surveillance data such as media. It may be, for example, a data source of surveillance videos, audio files, biometric data, license plate read events, a criminal data source, biometric data, calls to law enforcement (e.g. 911 calls), etc. The data source(s) may also be one or more devices for generating surveillance records, such as a camera that generates images or video, a badge reader that generates badge read events, a microphone that generates audio files, etc. The data source(s) may be queried by the system 100, the client computing device 130 and/or the LLM running on the external servers 120.

The data source(s) 110 may have searchable categories (also referred to herein as searchable parameters), which are the things you can search in the data sources 110. In some systems, these searchable categories may change over time. As described above, searchable parameters may increase if, for example, new types of video metadata become available thanks to new analytics. For example, cameras running analytics modules (or server software applying analytics to received video) may today be able to detect a vehicle make and model. Later, these cameras may be upgraded, or new more capable cameras may be connected to the system that can detect new types of makes and models, or new characteristics to vehicles such as damage, the presence of roof racks, etc. In such a case, the data source(s) 110 may have new searchable parameters meaning that new things can be searched. Searchable parameters can define what can be searched in the data source. For example, the different types of metadata in video that can be searched or the vehicle characteristics that can be searched are searchable categories.

### Exemplary Software Architecture for Generating a Structured Data Source Query Using an LLM:

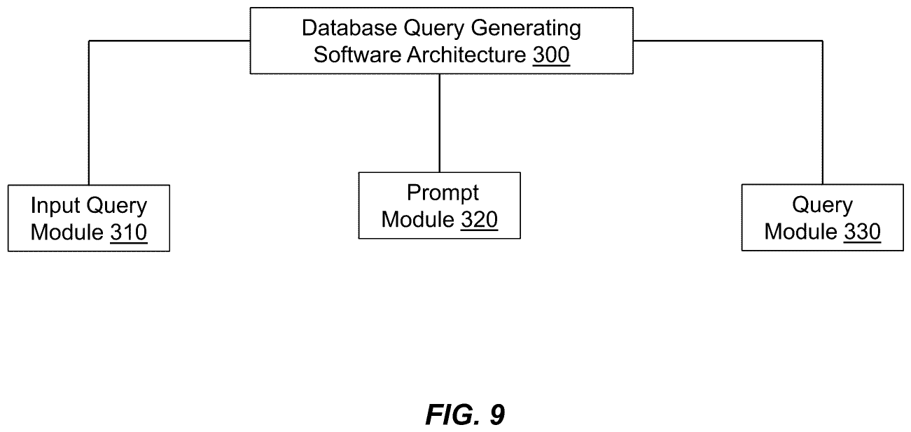

Reference is made to FIG. 9, illustrating an exemplary software architecture 300 for generating a structured data source query using an LLM.

For purposes of illustration, the system 100 is described herein as having program code, stored in memory 101, that includes the input query module 310, the prompt module 320 and the query module 330. Each of the input query module 310, the prompt module 320 and the query module 330 includes program code configured to implement the functionality of the modules as are described herein.

The input query module 310 includes program code stored in memory 101 that, when executed by the processor 102, causes the processor 102 to receive an input query in natural language inputted by the user or generated by a system. The input query may be provided as text (a string of characters) entered by the user in a graphical user interface displayed on, e.g., a display 135 of the remote computer 130, an audio file, etc. For the purpose of illustration, it will be presumed herein that the input query is text entered by the user, but it will be appreciated that other known input methodologies could be employed, such as voice input, implementing for example speech-to-text. The input query is the search request provided by the user, defining the nature of search to be conducted in one or more data sources of surveillance records. For instance, the input query may be the following string of characters: “look for videos of a man with a skull t-shirt in the building at 1 Square Samantha today between 1 PM and 3 PM”.

In some embodiments, the input query module 310 may cause the processor 102 to parse the string of characters received as the input query.

The prompt module 320 includes program code stored in memory 101 that, when executed by the processor 102, causes the processor 102 to generate an LLM query for transmission and processing by an LLM to generate a structured search query. The LLM query is the instructions and information for transmission to the LLM for causing the LLM to generate an output when processing the LLM query. The prompt module 320 causes the processor 102 to receive the input query from input query module 310. The prompt module 320 causes the processor 102 to generate an LLM query, including the input query and the prompt (e.g. system prompt), for transmission to the LLM, instructing the LLM to generate a structured search query for querying one or more data sources in accordance with the received input query in natural language. As such, the prompt module 320 may cause the processor 102 to generate a system prompt comprising instructions for causing the LLM to perform one or more actions in accordance with the system prompt, such as instructions to generate a database system query such as an API call for communicating with the one or more data sources 110, for including a permission level in the outputted structured search query associated with the user, to confirm that the user has security clearance for accessing the one or more data sources 110, etc. The system prompt may be parametrised according to the searchable parameters. More specifically, the system prompt may define what constitutes a valid database system query within the searchable parameters. For example, the system prompt may provide the LLM with the searchable parameters and the proper format for searching through the searchable parameters, e.g. the proper format for an API call to search the data source(s) 110. The prompt module 320 causes the processor 102 to transmit the LLM query to the LLM. In some embodiments, the prompt module 320 may cause the processor 102 to generate an API call for communicating with an application programming interface (API) of the LLM.

The query module 330 includes program code stored in memory 101 that, when executed by the processor 102, causes the processor 102 to receive the structured data source query generated by the LLM and transmit the structured data source query to the one or more data sources 110 to be queried. When the structured data source query includes an API call, the query module 330 may cause the processor 102 to transmit the structured data source query to the API of the data source 110, for accessing and querying the data source 110.

The query module 330 may cause the processor 102 to receive the search results that have been queried from the one or more data sources 110 (e.g. one or more surveillance records retrieved in response to the query). The processor 102 may then be caused by the query module 330 to transmit the search results to the client computing device 130 from which originated the initial input query. In some examples, the query module 330 may cause the processor 102 to generate a prompt for the LLM with the queried search results, the prompt instructing the LLM to summarize the queried search results. In some examples, the query module 330 may cause the processor 102 to generate a prompt for the LLM with the queried search results, the prompt instructing the LLM to compare the queried search results to the structured data source query and/or the input query to analyze whether the received queried search results adequately answer the structured data source query and/or the input query. In some instances, the processor 102 may be caused to include in the prompt to the LLM instructions to generate a further structured data source query from the input query if the LLM determines that the received queried search results do not adequately answer the structured data source query and/or the input query.

In some embodiments, the query module 330 may cause the processor 102 to transmit the credentials of the user or system, tied to the permission level of the user or the system, with the structured database query. The data source 110 receives the credentials along with the structured database query (for verification if the user or system has the proper credentials for accessing the surveillance records found within the data source 110).

### Exemplary Method of Querying a Data Source Using a Structured Data Source Query Generated by an LLM:

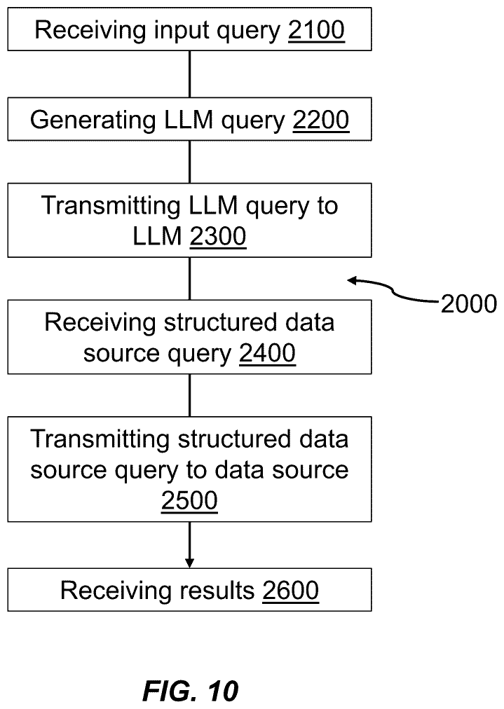

Reference is now made to FIG. 10, illustrating an exemplary method 2000 of querying a data source using a structured data source query generated by an LLM. The method 2000 may be performed by the system 100. However, it will be understood that the method 2000 may be performed by any system in accordance with the present teachings.

An input query provided by a user is received at step 2100. The input query specifies the nature of the search that the user or system is looking to perform through one or more data sources. For instance, the input query may be entered on a graphical user interface generated by a client application program as a series of characters forming one or more phrases. In some instances, the input query may be or include a selection of one or more options provided in a series of fields listing categories of characteristics to define the scope of the query (e.g. categories may include (date), (location), (time), (type of record), (type of crime), etc.) In some embodiments, the input query may be or include an audio file, where the input query is given as instructions provided orally.

In some instances, the input query may be accompanied by metadata providing related information on the input query. The metadata may be fields containing information related to the input query in natural language, such as an identifier related to the user account that generated the unique identifier, an IP address of the remote computing device that generated the unique identifier, a time for when the unique identifier was generated, a permission level corresponding to a security clearance level for the user or system that generated the unique identifier, etc.

An LLM query is generated for an LLM, containing instructions and data to cause the LLM to convert the received input query into a structured data source query for querying one or more data sources at step 2200. The LLM query includes the input query and a prompt, where the prompt includes instructions to be processed by the LLM to generate the structured data source query from the input query. The prompt may include other instructions for processing by the LLM. For instance, the prompt may cause the LLM to generate an API call for the API of the data source to be queried by transmitting the structured data source query to the data source. As such, the API call that accompanies the structured data query may call upon the API in order to access the related data sources, for retrieving the surveillance records corresponding to the structured data source query. In some instances, the LLM query may include information on credentials or a clearance level of the user who or system that originated the input query (e.g. a unique identifier or passcode for that user or system). The unique identifier may be provided as part of the LLM query, where the prompt of the LLM query may instruct the LLM to provide the unique identifier as accompanying information with the structured data source query, such that the data source or API can evaluate the unique identifier to determine if the user or system has authorization to access some or all of the surveillance records of the data source.

In some instances, the metadata that may accompany the input query may also be provided as part of the LLM query to be provided to the LLM, where the metadata may provide additional context information on the input query for the LLM to generate the corresponding structured data source query. The metadata may be fields containing information related to the input query in natural language, such as an identifier of the user account that generated the unique identifier, an IP address of the remote computing device that generated the unique identifier, a time for when the unique identifier was generated, a permission level corresponding to a security clearance level for the user or system that generated the unique identifier, etc.

In some instances, LLM query may include a system prompt for causing the LLM to generate the structured data source query in accordance with a format or style based on the configuration of the one or more data sources to be queried.

The following is an example of a system prompt generated to be transmitted including instructions to generate content for an API call in the output:

System:
You are responsible for creating a JSON document used for an API to search for
objects and individuals within CCTV recordings.
Do not answer with anything other than JSON.
The output must contain a suitable start and end detection time range in the field
‘detectionTimeRange’ based on user input and current time.
If the user specifies a duration (e.g. ‘in the last 4 hours’ or ‘4pm to 5pm), use
exactly that duration as a time range.
If the user specifies a point in time (e.g. ‘15min ago’ or ‘yesterday’), an time range
should be assumed using an appropriate margin around the specified time.
For example: when the user asks for the last 10 minutes the time range be from
15 minutes to 5 minutes in the past.
The current time is 2024-07-11T13:30:02.0586560Z.
If the user specifies a past point in time rather than a duration, make sure to add a
suitable duration before and after.
For example: when the user asks for results at 4am today, select a time range
between 3am and 5am.
The output must contain filters suitable to the user query.
Valid people clothing and vehicle colors are ‘White’, ‘Green’, ‘Red’, ‘Black’, ‘Blue’,
‘Yellow’.
Valid vehicle types are ‘Bike’, ‘Car’, ‘Truck’, ‘Bus’.
Consider the vehicle type ‘Bike’ to include any common 2-wheeled vehicle like
motorcycles.
Not directly supported colors should be mapped to the closes valid colors.
Not directly supported vehicle types should be mapped to the closest valid vehicle
types.
Consider using multiple alternative colors or vehicle types in the “oneOf’ field.
Try to map well-known brand names of vehicles to their respective vehicle types.
Try to map names of people to the ‘Person’ class.
If no object class can be derived from the user input, the filter should match
‘Person’ or ‘Vehicle’ with respective attributes (if applicable).
If no attribute filter can be derived from the user input for a given class, an empty
object should be used to search for that class with any attribute.
If the clothing type (top/bottom) can't be derived from the user input, the response
should contain two person filters.
One for the respective top clothing color and another person filter with the
respective bottom clothing color.

The system prompt may also specify a format for the output generated by the LLM (in the present example, the format is a JSON schema):

The output must conform to following JSON schema:
‘‘‘json
{“type”:“object”,“properties”:{“reasoning”:{“type”:“string”},“payload”:{“type”:“object
”,“properties”:{“person”:{“type”:“array”,“items”:{“type”:“object”,“properties”:{“topCl
othingColor”:{“type”:“object”,“properties”:{“oneOf”:{“type”:“array”,“items”:{“type”:“
string”,“enum”:[“White”,“Black”,“Green”,“Blue”,“Red”,“Yellow”]}}}},“bottomClothin
gColor”:{“type”:“object”,“properties”:{“oneOf”:{“type”:“array”,“items”:{“type”:“string
”,“enum”:[“White”,“Black”,“Green”,“Blue”,“Red”,“Yellow”]}}}}}}},“vehicle”:{“type”:“a
rray”,“items”:{“type”:“object”,“properties”:{“vehicleColor”:{“type”:“object”,“properti
es”:{“oneOf”:{“type”:“array”,“items”:{“type”:“string”,“enum”:[“White”,“Black”,“Gree
n”,“Blue”,“Red”,“Yellow”]}}}},“vehicleType”:{“type”:“object”,“properties”:{“oneOf”:{“
type”:“array”,“items”:{“type”:“string”,“enum”:[“Bus”,“Bike”,“Car”,“Truck”]}}}}}}},“det
ectionTimeRange”:{“type”:“object”,“properties”:{“start”:{“type”:“string”,“format”:“d
ate-time”},“end”:{“type”:“string”,“format”:“date-time”}}}}}}}
[additional details for other types of requests such as LPR related request or
access control related requests]
’’’

The instructions for generating the prompt may cause the prompt to include part of the user search query may be history of past user search query (ies) and corresponding output(s) generated by the LLM:

Prior search 1:
User: Find the Woman in the Red dress
Context: {Software version: 1.2.3; modules: video, access control, LPR; active
pane: live video; selected device: camera 01, camera 02; current action: viewing
live video; recent pane: live video; recent selected devices: camera 01, camera
02, camera 06, camera 09; recent actions: object tracking}
Assistant: {“reasoning”:“Not supported: classification (woman), clothing type
(dress)\nSearching for a *person* with a *top clothing color* containing
*red*.”,“payload”:{“person”:[{“topClothingColor”:{“oneOf”:[“Red”]}}]}}
Prior search 2:
User: Intruder with blue shirt and grey trousers, 30 minutes ago
Context: {Software version: 1.2.3; modules: video, access control, LPR; active
pane: live video; selected device: camera 01, camera 02; current action: viewing
live video; recent pane: live video; recent selected devices: door 02, camera 06,
camera 09; recent actions: access control, door view, object tracking}
Assistant: {“reasoning”:“Not supported: classification (intruder), clothing type
(trousers), color (grey), door forced open (door 02)\nSelected Time Range: today
[40min ago, 20min ago]\nSearching for a *person* with a *top clothing color*
containing *blue* and *bottom clothing color* containing *white* or *black* or a
door forced open event on door
02.”,“payload”:{“person”:[{“topClothingColor”:{“oneOf”:[“Blue”]},“bottomClothingC
olor”:{“oneOf”:[“White”,“Black”]}}],“event”:[“doorforcedopen”:(“door02”)],“detectio
nTimeRange”:{“start”:“2024-07-11T12:50:02.058656Z”,“end”:“2024-07-
11T13:10:02.058656Z”}}}
Prior search 3
User: red honda
Context: {Software version: 1.2.3; modules: video, access control, LPR; active
pane: hit list read; selected device: LPR camera 03; current action: LPR list; recent
pane: access control, LPR hitlist; recent selected devices: LPR camera 03, badge
reader 04; door 02; recent actions: LPR viewer; badge read viewer}
Assistant: {“reasoning”:“Not supported: vehicle brand
(honda), hitlist(yes)\nSearching for a *vehicle* with a *vehicle type* containing *car*
or *bike* and *vehicle color* containing *red* and listed in the
hitlist.”,“payload”:{“vehicle”:[{“vehicleColor”:{“oneOf”:[“Red”]},“vehicleType”:{“one
Of”:[“Car”,“Bike”]},“hitlist”:{[“yes”]}}]}}

The LLM query includes the input query (e.g. the string of characters received as user input for the current user search query:)
USER: “find the guy in the red shirt”

The generated prompt is transmitted to the LLM at step 2300. In some instances, the LLM may have an API, where calling the API permits interaction with the LLM. In these instances, the prompt may be accompanied with an API call for communicating with the API of the LLM. The LLM then executes the action in accordance with the prompt, generating the structured data source query and, optionally, any other output in accordance with the received prompt. The output of the LLM may be in the form of a string of characters, forming the structured data source query and, optionally, any other output in accordance with the received prompt.

The structured data source query generated by the LLM may be received at step 2400 by the LLM. The structured data source query defines one or more searchable categories or parameters (categories of information related to the surveillance record, where the one or more searchable categories are searchable when performing the query). Different types of surveillance records may include different searchable categories. Different data sources may include different searchable categories. For instance, the one or more searchable categories may be metadata tags or categories, where corresponding values for each of the metadata tags or categories may be related, as couplets, to the metadata tags or categories. For instance, exemplary metadata tags may be {time}, {date}, {location}, {object_type}, etc.

The structured data source query is transmitted to the one or more data sources to be queried at step 2500. In some embodiments, where there are a plurality of data sources to be queried, the structured data source query may be transmitted to a server that, subsequently, directs the structured data source query to the appropriate data source(s), in accordance with the instructions provided in the structured data source query (e.g. based on the nature of the surveillance records to be queried and the type of surveillance record stored in a given data source).

In some embodiments, when the structured data source query is accompanied by an API call generated by the LLM, the API call may call upon the API of the related data source, the called API then processing the received structured data source query for causing a performance of the corresponding query in the data source based on the configuration of the data source. In some instances, when the structured data source query is accompanied by information on a permission level of a user or system that provided the initial input query to access surveillance records based on security clearance, the data source, or API corresponding to the API, may perform an analysis to determine if the user or system has authorization to access the surveillance records contained within the data source based on the permission level. If a determination is made that the user or system does not have authorization to access the surveillance records, a response may be generated and transmitted back indicating the lack of clearance.

In some instances, a verification of the permission level may be performed by the system that generates and transmits the prompt for the LLM at steps 2200 and 2300, and transmitted the structured data source query to the LLM at step 2500. The system may verify the permission level of the user or system (e.g. by comparing the unique identifier of the user or system to a table or records of permission levels based on unique identifiers). If a determination is made that the user or system does not have authorization to access the surveillance records, a response may be generated and transmitted back to the computing device of the user or to the system that generated in the initial input query, indicating the lack of clearance.

The results are received from the one or more queried data sources at step 2600. The results may be transmitted to the computing device of the user or to the system that generated the initial input query. The received results may be stored in a data source in association with the related input query or structured data source query (e.g. as a data set) to archive a history of queries (e.g. related to a user account, a system, etc.)

The results may be caused to be displayed on a graphical user interface generated on a display of a computing device of a user who generated the input query.

In some instances, the received results of the query may be transmitted (with a prompt) to the LLM for analysis. For instance, the generated prompt that is transmitted with the queried results may cause the LLM to analyze the queried results to generate a summary of the search results. The summary generated by the LLM may then be received from the LLM.

In some instances, the prompt that accompanies the queried results and that is transmitted to the LLM may be to cause the LLM to analyze the search results. In some embodiments, the prompt may be accompanied by a history of search results (corresponding to previous searches), along with their related input queries and/or structured data source queries, and/or a chat history with the LLM, with instructions to the LLM as part of the prompt to cause the LLM to interpret the results. The instructions defined within the prompt to interpret the queried results may be to cause an identification of elements of interest within the queried results. The nature of the elements of interest may be defined by the user or system (as part of, derived from or accompanying the input query that is the basis of the generated structured data source query that causes the retrieval of the queried results). The nature of the elements of interest may also be determined by the LLM, in accordance with the instructions defined by the prompt, such as an identification of a suspicious character, or an identification of criminal activity.

In some instances, the instructions defined within the prompt to interpret the queried results may be to cause the LLM to suggest additional search options or a subsequent action in accordance with the queried results. The suggestion generated by the LLM may be in the form of a string of characters. The suggestion generated by the LLM may be transmitted to the computing device of the user or to the system that generated the input query. In some instances, the suggestion generated by the LLM may be processed by logic in communication with the LLM, where the logic may cause the generation of a new prompt to cause the generation of a new structured data source query by the LLM in accordance with the suggestion generated by the LLM. In some instances, instead of a suggestion, the output by the LLM may be new structured data source query to perform an additional search.

For instance, the prompt may cause the LLM to determine, by analyzing the received queried results, that the user or system generating the input query, did not have sufficient clearance to access surveillance records in one or more data sources, thereby resulting in the received query results not answering the initial input query. The response generated by the LLM may include an output that identifies a type of surveillance record that could not be accessed due to insufficient clearance, or to identify one or more data sources that can be accessed by the user or the system, based on the input query, that contains surveillance records to respond to the input query, that the user or system has permission to access based on the security permission level of the user or system.

In some instances, the prompt to cause the LLM to interpret the search results may cause the LLM to generate as an output an indicator that a feature of the initial input query cannot be searched. For instance, if the initial input query is “find a bald man with an anchor tattoo that was in Jimmy's Shopping Mall on October 28”, the LLM, analyzing the queried results and the input query, may determine that the feature of a tattoo type cannot be searched. The LLM may generate as an output a message indicating that a tattoo type cannot be searched. The LLM output may include an alternative search feature to be queried instead of the tattoo type.

### Exemplary Method of Updating a Surveillance Records Search Tool:

Reference is now made to an exemplary method of updating a surveillance records search tool for searching data source of surveillance records, the data source having searchable parameters. The method may be performed by system 100. It will be understood that the method may be performed by any other system in accordance with the present teachings.

A data representation of a system prompt is provided, to be transmitted along with user query to an AI model, the system prompt defining instructions on a manner of structuring a structured data prompt for the data source in accordance with the searchable parameters of the data source. Searchable parameters are categories of information that can be searched in the data source. For example, searchable parameters may be the different types of metadata in video that can be searched or the vehicle characteristics that can be searched (when the surveillance record is a video). The data representation of the system prompt may contain template elements each including portions of a potential system prompt, and wherein to generate an LLM query includes building a system prompt with a subset of the template elements. The building the subset of template elements may be selected on the basis of the user query. A data representation is data from which the system prompt can be produced in a form that is acceptable by the LLM (e.g. which can simply be the system prompt itself as a string, or the form could contain several parts (templates) from which to build a system prompt based on the input query).

A modification, replacement or supplementation of the data representation of the system prompt is performed to define instructions on a manner of structuring a structured data prompt for the data source in accordance with different searchable parameters of the data source (e.g. when the searchable parameters change, e.g. we support new metadata from new video analytics tools). The data representation may be a text containing a system prompt.

An input query is obtained (e.g. from a user, from a system), the input query including natural language (“identify a stolen red Toyota on Stanley Street.”)

The data representation of the system prompt may be accepted.

The LLM query may be generated for a large language model (LLM) including a portion made with the input query and a portion made with the data representation of the system prompt. The LLM query may include the input query and the system prompt.

It will be understood that the memory may be distributed, where the application program and the system prompt may not be located in the same physical memory.

The following example is provided to enable the skilled person to better understand the present disclosure. As it is but illustrative and representative examples, it should not limit the scope of the present disclosure. It is only added for illustrative and representative purposes. It will be understood that other examples may be used to further illustrate and represent the present disclosure without departing from the present teachings.

### Example of Querying a Data Source Using a Structured Data Source Query Generated by an LLM:

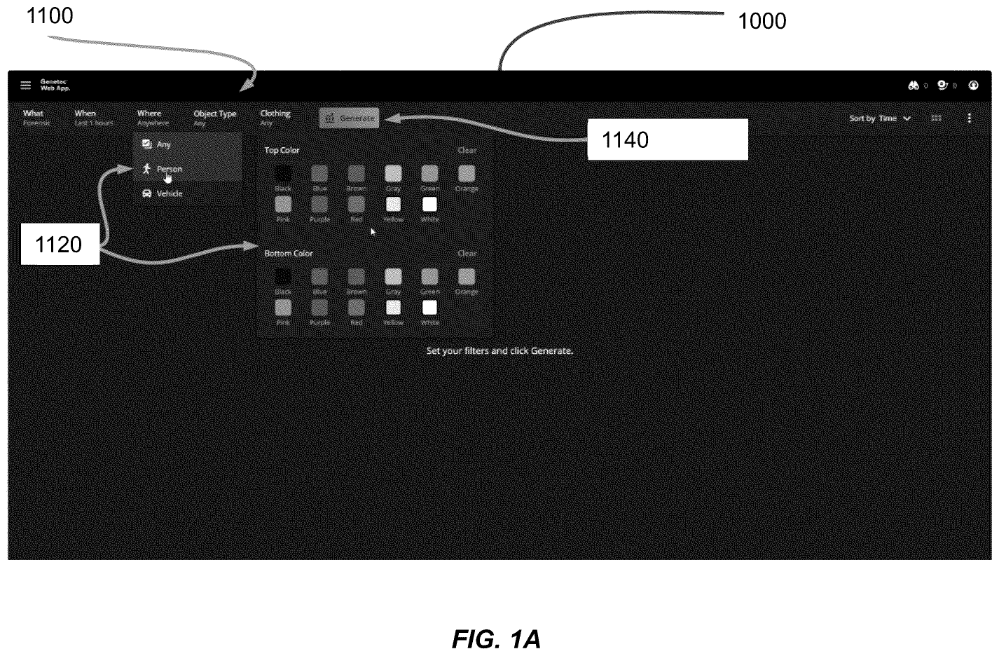

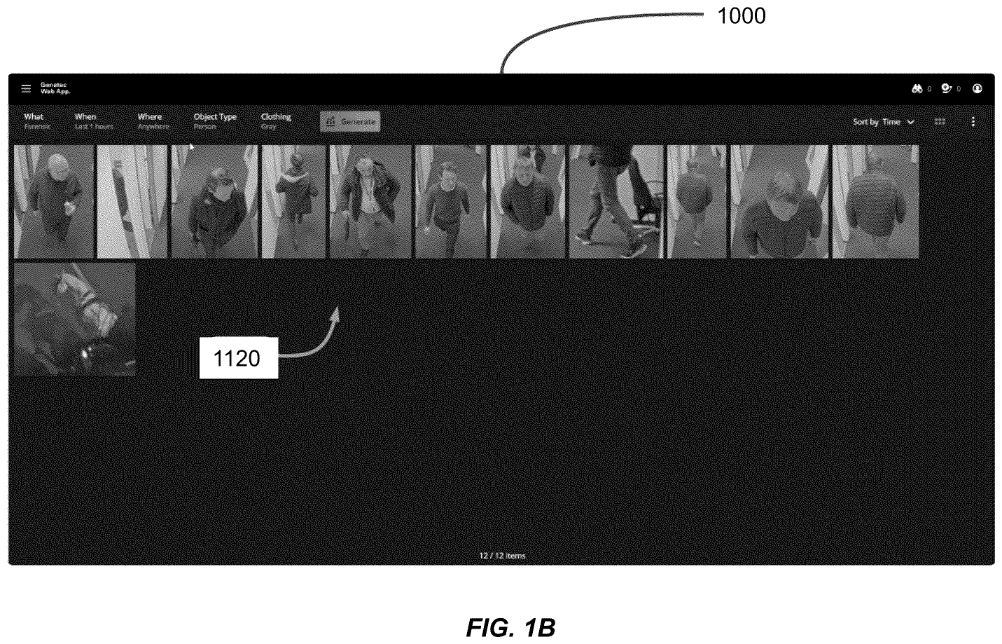

With reference to FIG. 1A, a search window 1000 is illustrated. The search window 1000 is an interactive graphical user interface which can receive input from and display output to an operator and may be one application amongst many in a surveillance software platform. To perform a search for surveillance records, the operator interacts with category selectors 1100, via which the operator can specify characteristics for the search query. In some cases, interacting with a category selector 1100 causes a dropdown menu 1120 to be displayed, via which the operator selects from a number of preset characteristics. In some other cases, interacting with a category selector 1100 causes a different type of input graphical element to be displayed, such as a slider, a text box, or the like. When the operator completes entry of their desired characteristics for the search, the operator interacts with a search element 1140, which launches the search, using the characteristics provided by the operator. With reference to FIG. 1B, once the search is complete, search results 1200 are displayed in the search window 1000.

In the embodiment illustrated in FIGS. 1A-B, the search window 1000 is used to obtain a search query from the operator that is structured based on metadata categories associated with the surveillance records stored in the repository. For example, each of the category selectors 1100 is indicative of one type of metadata for each of the surveillance records: temporal metadata, location metadata, object-type metadata, visual presentation metadata, and the like. Thus, by inputting their desired characteristics via the dropdown menus 1120 and/or via other graphical input elements, the operator is constructing a structured data source query which can be used to search the repository of surveillance records. The structured data source query can take any suitable form or format: in some cases, the structured data source query is a textual string; in some other cases, the structured data source query is an array or other data structure. In some cases, the structured data source query is composed of query couplets, in which one element of a couplet is a metadata category, and the other element of the couplet is a metadata characteristic. Other approaches are also considered.

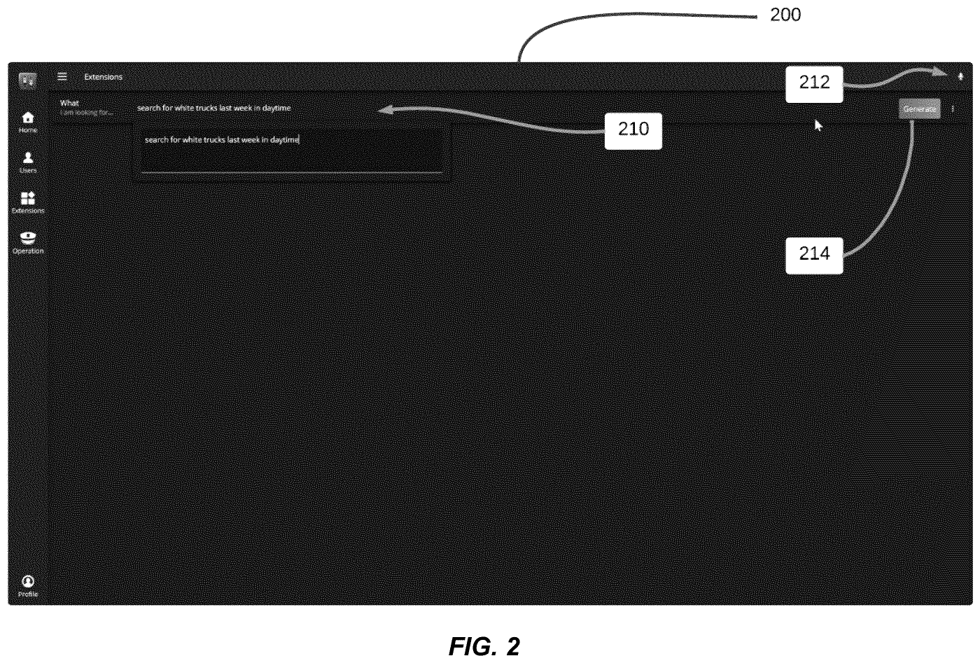

With reference to FIG. 2, a search window 200 is illustrated. The search window 200 is also an interactive graphical user interface which can receive input from and display output to an operator and may be another application amongst many in the surveillance software platform. Much like the search window 1000, the search window 200 is used by the operator to perform a search for records within the surveillance repository which match desired characteristics indicated by the operator. The search window 200 includes a query box 210 in which the operator enters an input query. In the embodiment illustrated in FIG. 2, the query box 210 receives input in the form of text, which may be of any suitable type, including natural language text. The search window 200 also includes a voice input button 212, which can enable the operator to input a query using voice commands. In some embodiments, the search window 200 (or another element of the surveillance software platform) is configured to interpret voice commands and transcribe them to text. In such embodiments, the transcribed voice command may be displayed as text within the query box 210. In some other embodiments, the search window 200 (or another element of the surveillance software platform) is configured to process voice commands as-is, without transcription, as will be described in greater detail hereinbelow. Whether as text, transcribed text, a voice command, or some other form of input, the operator provides an input query to the search window 200, which is used to search the repository of surveillance records.

To perform a search within the repository of surveillance records, the input query, which is not in and of itself a structured data source query, is translated into a more suitable query using a large language model (LLM). The LLM is trained to translate natural language into data source queries which are structured based on metadata categories associated with the surveillance records stored in the repository. The LLM may be trained to translate natural language of various forms, including natural language as provided by the operator via the query box 210, via voice command (using the voice input button 212), and/or in any other suitable format. In some cases, the LLM is also trained to translate natural language of various different languages, such that input to the query box 210 and/or via the voice input button 212 need not be in English (or whichever language is considered the default language for the surveillance software platform). Thus, in the example of FIG. 2, the input query “search for white trucks last week in daytime” is translated into a structured data source query.

By way of a non-limiting example, the structured data source query may take the form of query couplets composed of a data category such as a metadata category and a metadata characteristic:
{location: N/A} {date: after [
2020.01.01] AND before [2020.01.08]}
{time: after [0600] AND before [1800]}
{object_type: vehicle}
{size: large}
{color: white}

In this example, the input query does not specify a location; as a result, the “location” metadata category is assigned a metadata characteristic of “not applicable” (or “N/A”). The input query indicates “last week” and “in the daytime”, which means the metadata category “date” is assigned a metadata characteristic indicative of the previous week, and the metadata category “time” is assigned a metadata characteristic indicative of a time range of daytime. The indication of “trucks” in the input query is translated into two separate metadata categories: a first, “object_type”, which is assigned the metadata characteristic of “vehicle” (as opposed to “persons”, “luggage”, or the like), and the second, “size”, which is assigned the metadata characteristic of “large” (as opposed to “small”, which might return results of cars or other smaller vehicles). Finally, the input query indicates “white trucks”, which results in the metadata category “color” being assigned the metadata characteristic of “white”. Of course, the structured data source query may be structured in any other suitable fashion, as appropriate.

The LLM may be any suitable type of machine learning (ML) model trained to process text (whether written or in some other form), including transformer ML models with self-attention, rather than using convolutional neural networks. For example, the LLM may be trained to interpret the input query from the operator as a series of tokens, and the LLM may then predict a structured data source query as future tokens for the input query. In some embodiments, the LLM may be configured to interpret an audio recording or clip as the input query; in some other embodiments, audio recordings or clips provided by the operator as an input query may be transcribed to text prior to being provided to the LLM.

Training may be performed in any suitable manner, for example first to interpret natural language inputs, and then to produce structured data source queries as an output. In some cases, the LLM may be provided with examples of structured data source queries, which the LLM learns to then produce. Examples of structured data source queries may be obtained from operator interaction with the search window 1000, which generates structured data source queries via the category selectors 1100, or may be generated by simulating operator interaction with the search window 1000. Alternatively, a repository of previously used structured data source queries, for instance produced by past operator interaction with the search window 1000, may be used to train the LLM. Other approaches are also considered.

Advantageously, employing the LLM to produce the structured data source query permits for the input query to be translated into the structured data source query in a single operation. It is not required for the input query to be converted into an intermediary product, nor do any terms in the input query need to be converted to account for irregular vocabulary. Thus, there is no need for a dictionary of preferred terminology or for a parser to be applied to the input query. This also means that the LLM can adapt to changes in the vocabulary used by operators without the need for such a dictionary of preferred terminology or parser to be updated accordingly, nor is there a need to rely on external sources for such a dictionary.

Additionally, the structured data source query is not generated by converting the input query; in other words, the LLM does not rearrange or reprise terms from the input query when generating the structured data source query. Instead, the LLM generates a wholly new query, in the form of the structured data source query, based on the input query. This ensures that typographical mistakes, irregular formulations or terminology, or other potential issues with the input query are not replicated in the structured data source query produced by the LLM. Additionally, this approach ensures that the structured data source query, as produced by the LLM, is more consistently inline with the metadata categories established for the repository of surveillance records.

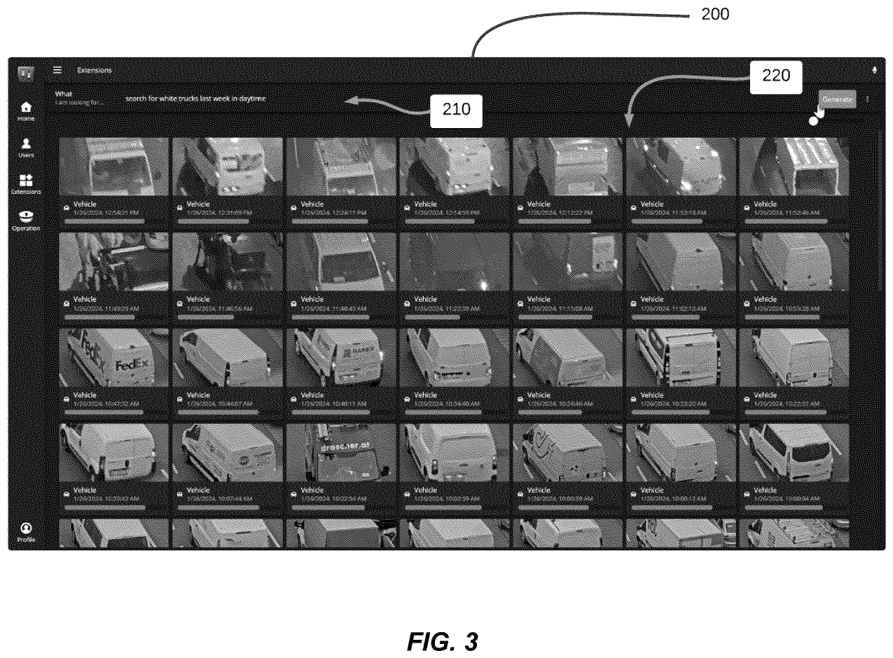

With additional reference to FIG. 3, the LLM translates the input query into a structured data source query which is then used to search the repository of surveillance records to identify query results 220, which can be displayed within the search window 200 in any suitable fashion. In the embodiment illustrated in FIG. 3, a plurality of query results 220 are displayed in a grid, with each query result 220 corresponding to a particular surveillance record stored in the repository. The query results 220 can present various information from their respective surveillance records, including an image of the vehicle, related metadata, and the like.

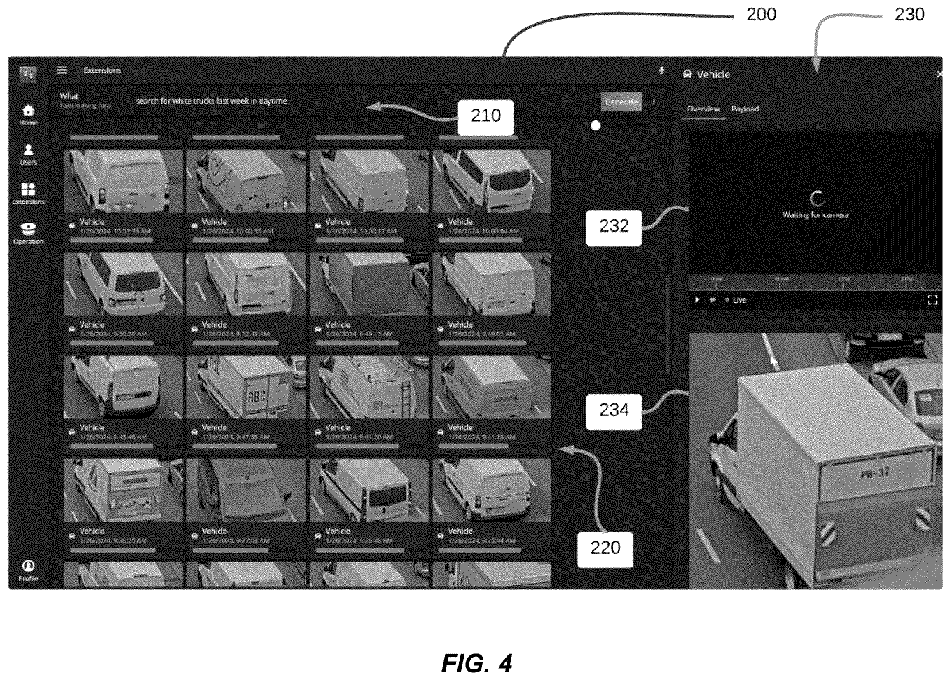

With additional reference to FIG. 4, in some embodiments the query results 220 are interactive, and when a user selects a particular one of the query results 220, a sidebar 230 may pop-out to provide additional information from the related surveillance record. In the illustrated embodiment, the sidebar 230 provides a video frame 232 which displays a portion of a surveillance video recording from which the surveillance record was generated. The sidebar 230 also provides an image frame 234 which displays the image of the vehicle to which the surveillance record relates. Other information, including relevant metadata, the vehicle's license plate, and the like, may also be displayed in the sidebar 230, as appropriate.

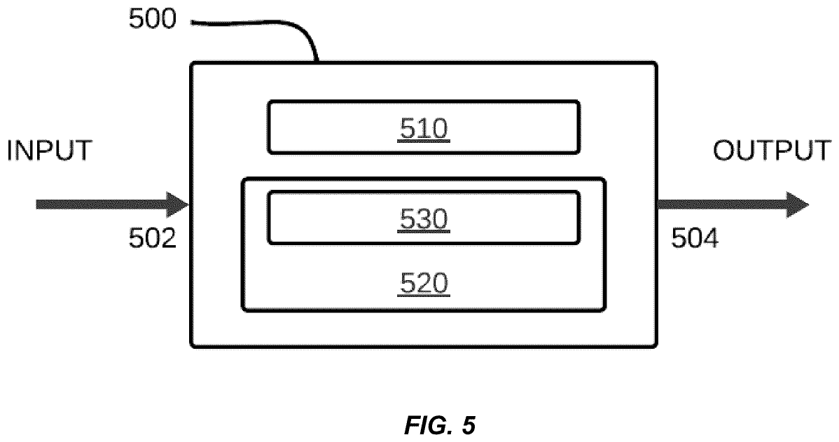

With reference to FIG. 5, there is illustrated a schematic diagram of an example computing device 500. As depicted, the computing device 500 includes at least one processor 510, a memory 520, and program instructions 530 stored within the memory 520, as well as input and output interfaces (I/O interfaces) 502 and 504, respectively. For simplicity, only one computing device 500 is shown; the various computing devices described herein may be embodied by one or more implementations of the computing device 500, which may be the same or different types of devices. The components of the computing device 500 may be connected in various ways including directly coupled, indirectly coupled via a network, and distributed over a wide geographic area and connected via a network, for instance via a cloud computing implementation.

The I/O interfaces 502, 504 may include one or more media interfaces, via which removable media or other data sources may be coupled, one or more network interfaces, or any other suitable type of interface. The I/O interfaces 502, 504 of the computing device 500 may additionally, in some embodiments, provide interconnection functionality to one or more input devices, such as a keyboard, mouse, camera, touch screen and a microphone, or with one or more output devices such as a display screen and a speaker, for instance devices via which a user may interact with a server. In embodiments in which the I/O interfaces 502, 504 include one or more network interfaces, the network interface(s) of the computing device 500 may enable the computing device 500 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The processor 510 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. The processor 510 may be configured for executing the instructions 530 stored within the memory 520. The memory 520 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically erasable programmable read-only memory (EEPROM), Ferroelectric RAM (FRAM) or the like.

In certain embodiments, the computing device 500 is operable to register and authenticate users (using a login, unique identifier, and password for example) prior to providing access to applications, a local network, network resources, other networks, and network security devices. The computing device 500 may serve one user or multiple users.

For example, and without limitation, the computing device 500 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods and/or implementing the systems described herein.

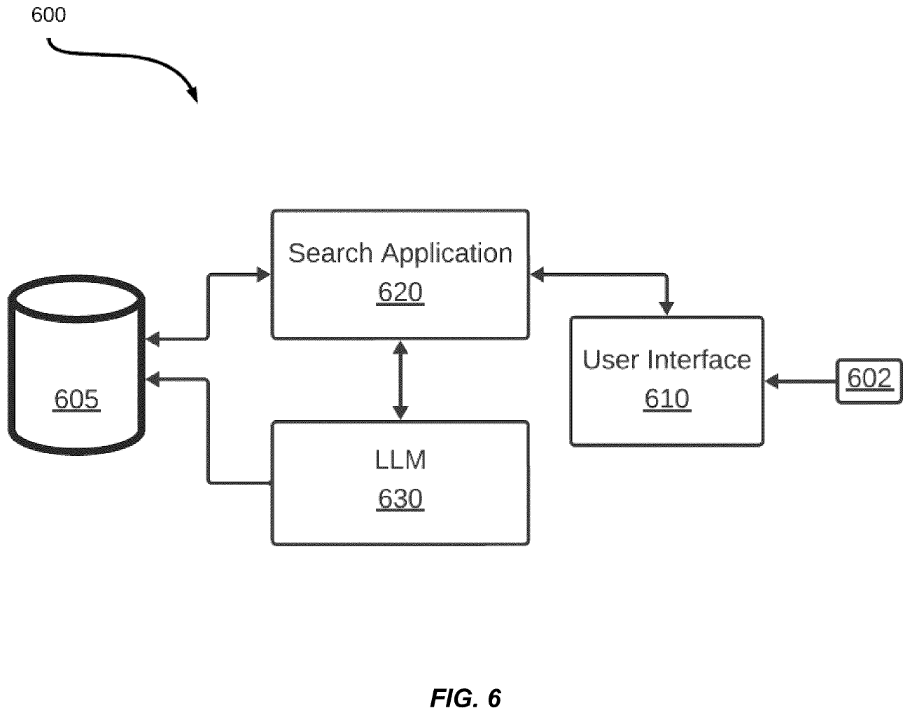

With reference to FIG. 6, a block diagram of an exemplary surveillance software platform is illustrated at 600 and is composed of a user interface 610, a search application 620, a LLM 630, and optionally of a surveillance record repository 605. The surveillance software platform 600 can receive input from input device 602, which may include various hardware (e.g., keyboards, touchscreens, microphones, etc.) and/or software (e.g., copy-paste input, input from remote users, etc.) input elements. The input is received at the user interface 610, which may display the input to an operator for confirmation, and may also be used to display other information to the operator.

The input received from the operator at the user interface 610 includes a search query, for instance the input query described hereinabove. The user interface 610 may pass the input query to the search application 620, which may be one of many applications forming part of the surveillance software platform 600. The search application 620 may then provide the input query to the LLM 630 for the LLM to translate the input query into a structured data source query, as described hereinabove. In some embodiments, the LLM 630 may provide the structured data source query to the surveillance record repository 605 directly; in some other embodiments, the LLM 630 returns the structured data source query to the search application 620, which in turn queries the surveillance record repository 605 using the structured data source query.

The search application 620 then receives query results from the surveillance record repository 605 and may then present the query results via the user interface 610. Additionally, the user interface may receive further input from the operator to interact with the query results, for instance to obtain additional information of context relating thereto, or to perform a new query by providing a new input query.

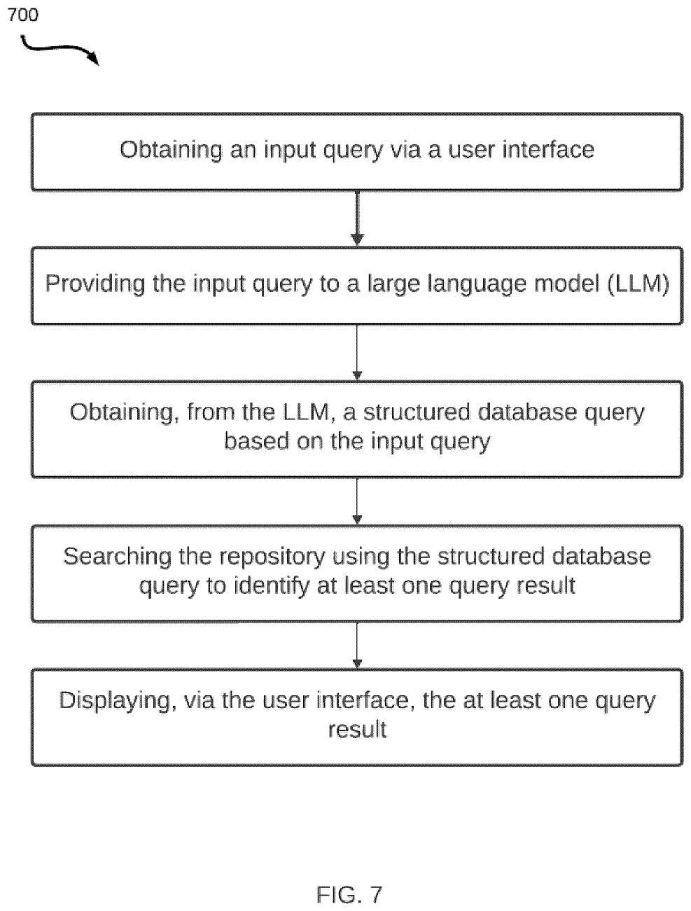

With reference to FIG. 7, there is illustrated a flowchart for a method 700 for searching a repository of surveillance records. An input query comprising natural language is obtained via a user interface. The input query is provided to a large language model (LLM), the LLM having been trained to translate natural language into data source queries structured based on metadata categories associated with the surveillance records stored in the repository. In some embodiments, instructions are generated and provided with the input query (e.g. as a system prompt) to generate an application programming interface (API) call for communicating with an application programming interface related to a data source to be queried by the LLM. These instructions for generating an LLM call may also include instructions to generate the content for producing an API call in a specific format (such as JSON schema).

The LLM may generate the structured data source query, corresponding to the natural language of the input query, along with the API call corresponding to the API call instructions, for querying the data source related to the API that is being called by the API call generated by the LLM. In some embodiments, the called API may modify the data source query received from the LLM in a format suitable for the data source to be queried, such as by converting the metadata category of the structured data source query to a corresponding and suitable metadata category of the data source to be queried.

In some instances, instructions may be generated and provided with the input query, as a system prompt, to cause the LLM to generate a query regarding how to generate a data source query for a given data source or query, based upon the configuration of the data source or system to be queried. Once the LLM receives the response regarding how to query the data source or system, the LLM may generate the structured data source query corresponding to the input query, structured accordingly to the response regarding how to query the data source or system.

In some examples, instructions may be generated and provided along with the input query to define or include permission information in the structured data source query generated by the LLM. The permission level defines an availability of data or a data source to be queried by the LLM based on a security clearance of the user or computing device of the user generating the input query. For instance, an input query may include, as e.g. metadata, a unique identifier for the user or the computing device of the user that generated the input query. The unique identifier may be included as information to be shared in the structured data source query to be transmitted to the data source to be queried, or the unique identifier may be analyzed by external logic to generate instructions for the LLM to include information on the clearance or accessibility of data to be queried by the user, e.g. based on the security clearance tied to the unique identifier, in the structured data source query. Results received in response to the structured data source query may be limited depending on the permission level tied to the user or computing device of the user that is the originator of the input query.

In some instances, instructions may be generated and provided to the LLM, along with the input query, to verify if the queried results are limited due to a security issue, where certain data in the data source is not accessible due to security reasons. The instructions may cause the LLM receiving the queried results to generate a response for the user or user computing device that generated the input query indicative that a security or permission restriction impeded the receiving of results in response to the structured data source query.

A structured data source query, based on the input query, is obtained from the LLM. The repository is searched using the structured data source query to identify at least one query result. The at least one query result is displayed via the user interface. In some instances, instructions may be generated and transmitted to the LLM (e.g. as a system prompt), along with the natural language of the input query, to cause the LLM to, once the LLM receives the one or more query results (e.g. from the data source or the user's computing device that originated the input query), generate a summary of the search results (e.g. in a text format, as an audio message, etc.) for transmission to the computing device of the user from which the input query originated. The instructions to summarize the query results transmitted to the LLM may include instructions regarding the format of the summary response that is to be generated by the LLM (e.g. audio, images, a text, etc.), a length of the summary response, etc.

In some instances, instructions may be generated and transmitted to the LLM, along with the natural language of the input query, to cause the LLM to analyze the query results received from the queried data source or the user computing device that originated the input query, in view of the input query or the structured data source query generated by the LLM. In some embodiments, the LLM may generate an adapted structured data source query following the analysis of the query results, to further query the data source to supplement or adapt the query results, to better respond to the initial input query originating from the computing device of the user.

The embodiments of the methods, systems, devices, and computer-readable media described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references have been made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, data source server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus, if one embodiment comprises elements A, B, and C, and a second embodiment comprises elements B and D, other remaining combinations of A, B, C, or D, may also be used.

The terms “connected” or “coupled to”, as well as any similar terms, may include both direct coupling (in which two elements that are coupled to each other contact each other) and indirect coupling (in which at least one additional element is located between the two elements).

The use of numerical ranges by endpoints in the present disclosure should be understood as including all numbers within that range (e.g., 1 to 5 includes 1, 1.25, 2, 2.5, 3, 3.69, 4, 4.33, 5, etc.). Where a range of values is qualified as being “greater than”, “less than”, etc., of a particular value, that value may or may not be included within the range, as appropriate.

Any direction or orientation described in the present disclosure, including but not limited to “top”, “bottom”, “left”, “right”, “upper”, “lower”, “above”, below”, as well as other directions and orientations, are described herein for clarity, and should be understood in reference to the drawings. These and other similar terms should not be understood as limiting of an actual device or system or of use of the device or system. Many of the devices, articles, or systems described in the present disclosure may be used in a number of suitable directions and orientations.

Any citation to references in this disclosure and during the prosecution thereof is made out of an abundance of caution. No citation should be construed as an admission that the cited reference qualifies as prior art or comes from an area that is analogous or directly applicable to the present teachings.

To aid the Patent Office, as well as any readers of any patent issued from this application, in interpreting the claims appended hereto, it is noted that none of the appended claims or elements of the appended claims, as pending or as granted, are intended to invoke 35 U.S.C. 112 (f) unless the words “means for” or “step for” are explicitly used in the particular claim or claim or claim element.

The technical solution of embodiments may be in the form of a software product. The software product may be stored in a non-volatile or non-transitory computer-readable storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and at least some of the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions, and alterations can be made herein without departing from the scope as defined by the appended claims.

For example, in the present description we provide an example where the Artificial Intelligence (AI) model is an LLM. The field of artificial intelligence is rapidly changing and different types of models are springing up. The label “LLM” may come to define types of models that are not appropriate for the presently-described functions and other types of models may arise with different labels that are. The skilled person is encouraged to ascertain what tools, particularly what AI models, may be used and to consider functioning alternatives as possible variants.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the examples described above and illustrated herein are intended to be examples only, and the appended claims are intended to include within their scope such processes, machines, manufacture, compositions of matter, means, methods, or steps.

Generally, all terms used in the claims are to be interpreted according to their ordinary meaning in the relevant technical field, unless explicitly defined otherwise herein. All references to a/an/the element, apparatus, component, means, step, etc., are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second”, etc. for different features/components of the present disclosure are only intended to distinguish the features/components from other similar features/components and not to impart any order or hierarchy to the features/components.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method for causing a searching of a data source of surveillance records, comprising:
obtaining an input query, the input query comprising natural language;
providing the input query to a large language model (LLM), for translating the natural language into a structured data source query based on searchable categories associated with the surveillance records stored in the data source;
obtaining, from the LLM, a structured data source query based on the input query;
transmitting the structured data source query to the data source to perform a search of the data source in accordance with the structured data source query to identify at least one query result; and
receiving the at least one query results.

2. The method according to claim 1, further comprising causing a display, via the user interface, of the at least one query result.

3. The method of claim 1, wherein the searchable categories are metadata categories.

4. The method of claim 3, wherein the searchable categories form with corresponding metadata characteristics query couplets.

5. The method of claim 1, wherein providing the input query to the LLM comprises providing the input query to the LLM without prior parsing of the input query.

6. The method of claim 1, further comprising generating and transmitting instructions to the LLM for generating an application programming interface (API) call for an API related to a data source to be queried with the structured data source query.

7. The method of claim 1, further comprising:
transmitting the at least one query results to the LLM; and
generating and transmitting instructions to the LLM to generate a summary of the at least one query result.

8. The method of claim 1, further comprising providing a permission level to the LLM, wherein the obtained structured data source query includes information related to the permission level.

9. The method of claim 1, further comprising:
transmitting the at least one query result to the LLM;
generating and transmitting instructions to the LLM for causing the LLM to analyse the at least one query result;
receiving the output of the analysis from the LLM; and
providing a response to a user computing device having generated the input query, the response corresponding to the received output.

10. The method of claim 9, wherein the instructions for causing the LLM to analyse the at least one query results further cause the LLM to compare the at least one query result to the input query or the structured data source query to verify if the at least one query result satisfies the input query or the structured data source query.

11. The method of claim 10, wherein the instructions further cause the LLM to interpret the at least one query results to determine if additional search of the data source, or of one or more additional data sources is required.

12. The method of claim 10, wherein the instructions further cause the LLM to interpret the at least one query results to determine if a category of information identified in the input query is not searchable.

13. The method of claim 12, wherein the instructions further cause the LLM to generate as an output a suggestion of an alternative category of information instead of the category of information identified in the input query that is not searchable.

14. The method of claim 1, further comprising:
generating and transmitting instructions to the LLM for causing the LLM to analyze the input query to determine if one or more categories of information related to the input query is not searchable; and
receiving an output from the LLM regarding if one or categories of information related to the input query is not searchable.

15. The method of claim 14, wherein the instructions to the LLM for causing the LLM to analyze the input query to determine if one or more categories of information related to the input query is not searchable, are to further cause the LLM to generate one or more alternative data categories to be searched related to one or more not searchable categories of information of the one or more categories of information; and wherein the received output includes the one or more alternative data categories to be searched related to one or more not searchable categories of information of the one or more categories of information.

16. The method of claim 1, wherein the obtained input query is accompanied by metadata providing context information surrounding the obtained input query.

17. The method of claim 16, wherein the input query is provided to the LLM along with the metadata providing context information or information derived from the metadata providing context information.

18. The method of claim 1, further comprising generating a system prompt defining instructions on a manner of structuring the structured data prompt for the data source, and providing the system prompt along with the input query to the LLM.

19. A system for causing a searching of a data source of surveillance records, comprising:
a processor; and
memory comprising program code that, when executed by the processor, cause the processor to:
obtain an input query, the input query comprising natural language;
provide the input query to a large language model (LLM), for translating the natural language into a structured data source query based on searchable categories associated with the surveillance records stored in the data source;
obtain, from the LLM, a structured data source query based on the input query;
transmit the structured data source query to the data source to perform a search of the data source in accordance with the structured data source query to identify at least one query result; and
receive the at least one query results.

20. A non-transitory computer-readable medium having stored thereon program instructions for causing a searching of a data source of surveillance records, the program instructions executable by a processing unit for:
obtaining an input query, the input query comprising natural language;
providing the input query to a large language model (LLM), for translating the natural language into a structured data source query based on searchable categories associated with the surveillance records stored in the data source;
obtaining, from the LLM, a structured data source query based on the input query;
transmitting the structured data source query to the data source to perform a search of the data source in accordance with the structured data source query to identify at least one query result; and
receiving the at least one query results.
